(19) United States
(12) Patent Application Publication
(10) Pub. No.: US 2007/0180161 A1
(43) Pub. Date: Aug. 2, 2007

(54) DMA transfer apparatus

(76) Inventors: Satoshi Asada, Osaka (JP); Taketoshi Yonezu, Osaka (JP); Satoshi Nagamine, Kyoto (JP)

Correspondence Address: MCDERMOTT WILL & EMERY LLP, 600 13TH STREET, NW, WASHINGTON, DC, 20005-3096, US

(21) Appl. No.: 11/701,504

(22) Filed: Feb. 2, 2007

(30) Foreign Application Priority Data
Feb. 2, 2006 (JP) 2006-025976

(51) Int. Cl. G06F 13/28

(52) U.S. Cl. 710/22

(57) ABSTRACT

To lighten the load on a processor in DMA transfer, a DMA transfer apparatus 13 for executing DMA transfer between local memory 16 that each processor has and global memory 15 shared by the processors, wherein a DMA transfer termination notification is issued to the destination determined by referencing a table 14 for managing destinations to which a notification of DMA transfer termination is to be sent.

### BACKGOURND OF THE INVENTION

1. Field of the Invention

This invention relates to a multiprocessor system including a plurality of processors and in particular to a DMA transfer apparatus for executing processor-to-processor DMA transfer.

2. Description of the Related Art

In a multiprocessor system, a plurality of processors can execute computation in parallel. Particularly, in an image processing field, processing high in parallelism is often performed and thus if a large number of processors exist, the time required for image processing can be shortened accordingly. However, the data to be processed needs to be divided for distribution to a plurality of processors before parallel computation is executed. When the data is divided, processor-to-processor data transfer is newly added to the processing time as overhead. Therefore, how processor-to-processor transfer can be executed at high speed for improving the final computation efficiency becomes a key.

Known as a related art of speeding up the processor-to-processor transfer is a function called DMA of executing direct transfer of data to be essentially transferred by a processor independently of the processor. While DMA transfer is executed, the processor can continue different processing and thus the processing speed can be increased. In the DMA transfer, the master processor monitors the start and completion of the DMA transfer and upon completion of the DMA transfer, the master processor sends a notification of the completion to a slave processor using communication means provided between the processors.

FIG. 9 is a chart to show a DMA transfer sequence. For example, to execute DMA transfer of the data managed by a master processor 10 to a predetermined area and execute processing by a slave processor 11 using the data after completion of the DMA transfer, the master processor 10 issues a transfer request for starting a DMA transfer apparatus 13 to the DMA transfer apparatus 13, the DMA transfer apparatus 13 issues a transfer termination notification to the master processor 10 after the DMA transfer termination, the master processor 10 issues a notification that data processing can be started because the DMA transfer terminates (processing start OK) to the slave processor 11 using processor-to-processor communications, and the slave processor 11 receiving the notification executes data processing. If the data processing in the slave processor 11 needs to be divided into several parts for execution as shown in FIG. 10, the DMA transfer sequence shown in FIG. 9 is executed a plurality of times.

By the way, in the multiprocessor system, every processor can become the master processor and thus a determination processing function for a DMA transfer termination notification is implemented in a control program of each processor. Therefore, upon completion of DMA transfer, a transfer termination notification is issued to all processors and thus a determination for the transfer termination notification needs also to be made in the processor not essentially requiring the notification. (For example, refer to JP-A-2002-163239)

Since each processor must determine a transfer termination notification issued to all processors from a DMA controller in the DMA transfer in the related art as described above, there is a problem of an increase in the load on the processor. Since the master processor must issue a notification (processing start OK) to each slave processor each time DMA transfer terminates, there is a problem of an increase in the load on the processor.

### SUMAMRY OF THE INVENTION

It is therefore an object of the invention to provide a DMA controller that can lighten the load on a processor in DMA transfer.

According to the invention, there is provided a DMA transfer apparatus for executing DMA transfer between local memory that each processor has and global memory shared by the processors, the DMA transfer apparatus including a table for managing destinations to which a notification of DMA transfer termination is to be sent; and control means for issuing a DMA transfer termination notification to the destination determined by referencing the table. According to the configuration, the DMA transfer apparatus issues a transfer termination notification directly to a specific destination without the intervention of the master processor, so that the load on the processor can be decreased. Since a transfer termination notification is issued only to a specific slave processor, the need for any other slave processor to determine the transfer termination notification is eliminated, so that the load on the processor can be decreased.

In the invention, the table manages the timing at which a notification of DMA transfer termination is to be sent, and the control means issues a DMA transfer termination notification at the timing determined by referencing the table. According to the configuration, the timing of a DMA transfer termination notification can be changed, so that processing for transfer data can be started without waiting for termination of every DMA transfer.

In the invention, the table manages a slave processor as the destination to which a notification of DMA transfer termination is to be sent or the table as the destination to which a notification of DMA transfer termination is to be sent. According to the configuration, if the destination to which a notification of DMA transfer termination is to be sent is set as the DMA transfer apparatus containing the table, it is made possible to execute DMA transfer successively and more than one DMA transfer can be executed efficiently.

According to the invention, the DMA transfer apparatus issues a transfer termination notification directly to a specific destination without the intervention of the master processor, so that the load on the processor can be decreased. Since a transfer termination notification is issued only to a specific slave processor, the need for any other slave processor to determine the transfer termination notification is eliminated, so that the load on the processor can be decreased.

### BRIEF DESCRIPTION OF THE DRAWINGS

In the accompanying drawings:

FIG. 1 is a block diagram to show the configuration of a multiprocessor system incorporating the invention;

FIG. 2 is a drawing to show a management table;

FIG. 3 is a chart to show a DMA transfer sequence;

FIG. 4 is a chart to show a DMA transfer sequence;

FIG. 5 is a chart to show a DMA transfer sequence;

FIG. 6 is a chart to show a DMA transfer sequence;

FIG. 7 is a drawing to show the structure of stream data;

FIG. 8 is a drawing to show memory-to-memory data copy;

FIG. 9 is a chart to show a DMA transfer sequence in a related art; and

FIG. 10 is a chart to show a sequence of executing DMA transfer more than once.

### DESCRIPTION OF THE PREFERRED EMBODIMENTS

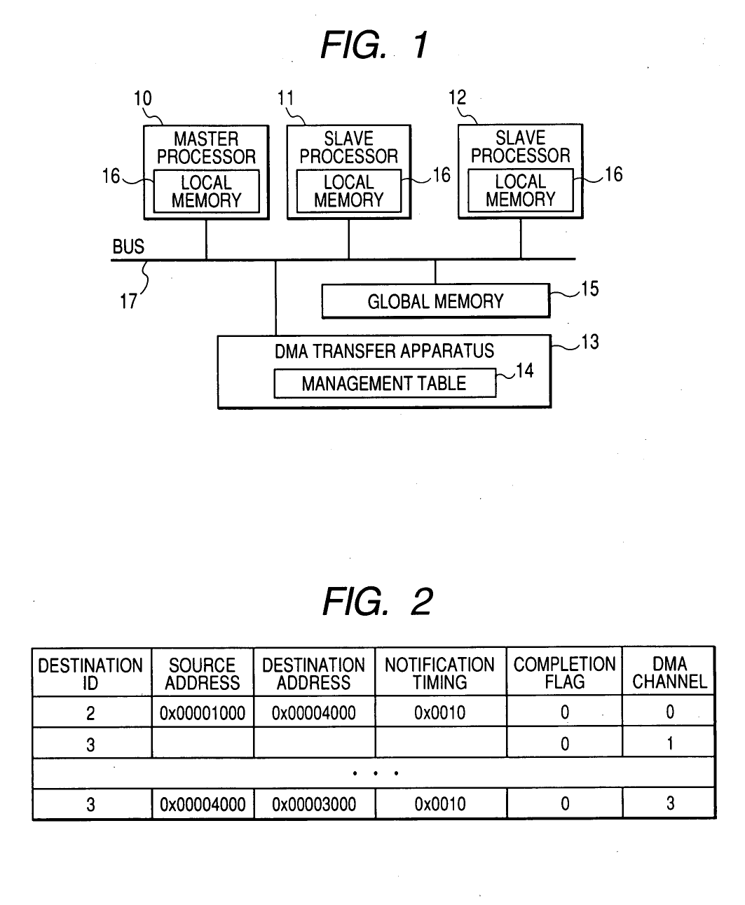

FIG. 1 is a block diagram to show the configuration of a multiprocessor system incorporating the invention. As shown in FIG. 1, the multiprocessor system is made up of a master processor 10, a slave processor 11, a slave processor 12, global memory 15, and a DMA transfer apparatus 13 which are connected through a bus 17. The number of the processors is not limited to three; in the embodiment, however, the three processors are described by way of example.

Each processor has local memory 16 for use as data memory when processor-proper processing is performed. The local memory 16 cannot directly be accessed from any other processor and processor-to-processor data transfer is executed as DMA transfer through the global memory 15. The global memory 15 is shared memory that can be used by the processors in common and is used as a common buffer area that can be used by the processors and as storage of common data when the processors conduct communications with each other.

FIG. 2 is a drawing to show a management table 14 that the DMA transfer apparatus 13 has. Destination addresses, source addresses, and DMA transfer termination notification destination IDs are set in the management table 14 as parameters. Further, notification timings, DMA transfer completion flags, and DMA channels (described later) are set. The management table 14 stores a plurality of records each containing a set of the parameters.

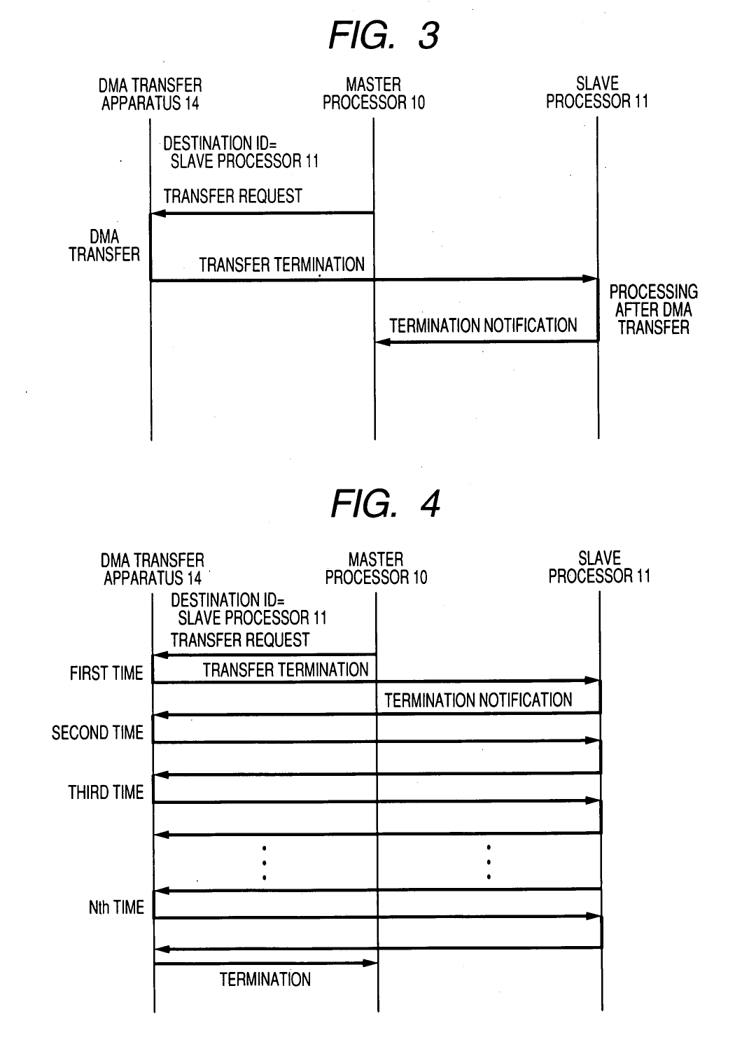

FIG. 3 is a chart to show a DMA transfer sequence. The master processor 10 issues a DMA transfer request to the DMA transfer apparatus 13. Upon completion of the DMA transfer, the DMA transfer apparatus 13 references the management table 14 and issues a transfer termination notification to the destination ID determining the slave processor set corresponding to the DMA transfer parameters (destination addresses and source address). At the point in time of execution of processing after the DMA transfer, the slave processor 11 issues a termination notification to the master processor 10. Issuing the termination notification to the master processor 10 may be omitted. A plurality of slave processors to which the transfer termination notification is to be issued may be set for issuing the transfer termination notification to each of the slave processors.

FIG. 4 is a chart to show another example of the DMA transfer sequence. For example, an operation sequence of executing DMA transfer of data stored in the local memory 16 of the master processor 10 to the global memory 15 and processing the data in the slave processor 11 will be discussed. The master processor 10 issues a first DMA transfer request to the DMA transfer apparatus 13. Upon completion of the first DMA transfer, the DMA transfer apparatus 13 references the management table 14 and issues a transfer termination notification to the destination ID determining the slave processor set corresponding to the first DMA transfer parameters (destination addresses and source address). Next, the master processor 10 issues a second DMA transfer request to the DMA transfer apparatus 13. Upon completion of the second DMA transfer, the DMA transfer apparatus 13 references the management table 14 and issues a transfer termination notification to the destination ID determining the slave processor set corresponding to the second DMA transfer parameters (destination addresses and source address). At the point in time of execution of processing after the DMA transfer, the slave processor 11 issues a termination notification to the master processor 10. The above-described DMA transfer is repeated N times, whereby the processing sequence can be executed.

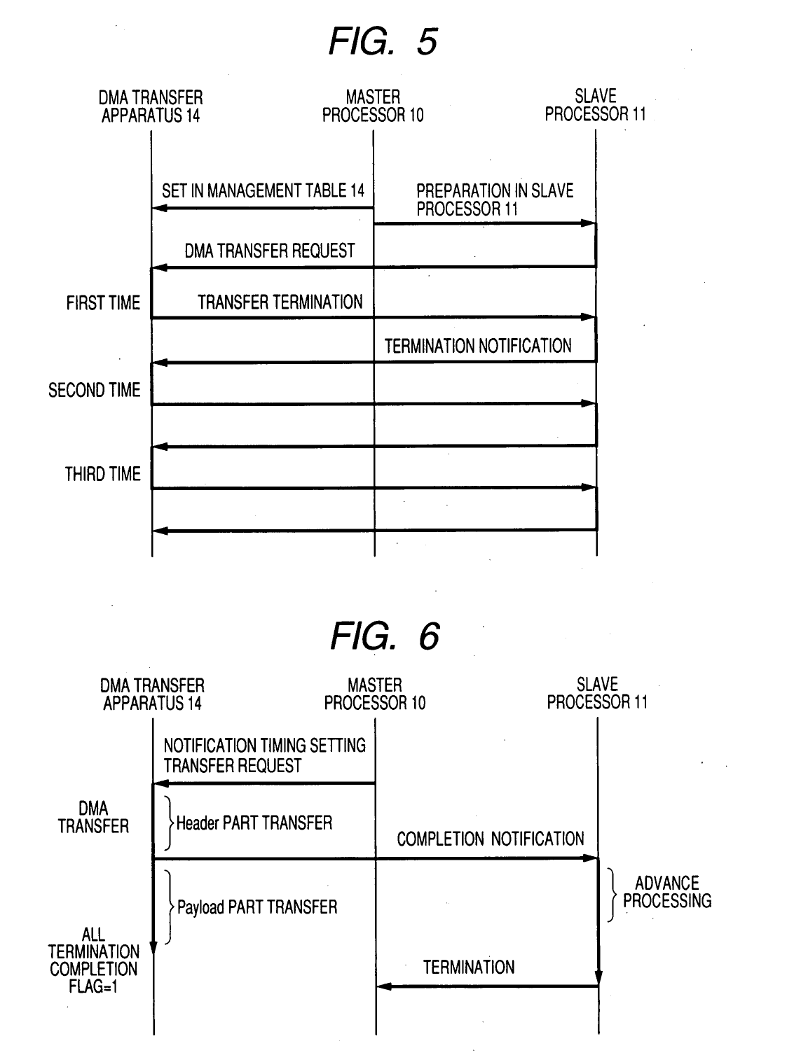

FIG. 5 is a chart to show still another example of the DMA transfer sequence. In the transfer sequence shown in FIG. 5, a DMA transfer request issued from the master processor is issued from the slave processor. The master processor 10 issues a processing start request to the slave processor 11. After executing necessary processing, the slave processor 11 issues a DMA transfer request to the DMA transfer apparatus 13. Upon completion of the DMA transfer, the DMA transfer apparatus 13 references the management table 14 and issues a transfer termination notification to the destination ID determining the slave processor set corresponding to the DMA transfer parameters (destination addresses and source address). The subsequent processing is similar to that in the DMA transfer sequence previously described with reference to FIG. 4.

According to the embodiment, the DMA transfer apparatus issues a transfer termination notification directly to a specific slave processor without the intervention of the master processor, so that the load on the processor in the DMA transfer can be decreased.

FIG. 6 is a chart to show still another example of the DMA transfer sequence. The master processor 10 issuing a DMA transfer request sets the notification timing in the management table 14 that the DMA transfer apparatus 13 has (see FIG. 2). The DMA transfer apparatus 13 references the management table 14 and issues a transfer termination notification to the destination ID determining the slave processor set corresponding to the DMA transfer parameters (destination addresses and source address). The issuance timing is defined as the notification timing set in the management table 14. Therefore, if the number of untransferred data pieces is defined as the notification timing, when the number of untransferred data pieces becomes equal or less than the number of data pieces, defined as the notification timing during the DMA transfer, a transfer termination notification is issued. The DMA transfer apparatus 13 continues DMA transfer of untransferred data and upon completion of DMA transfer of all data, sets a completion flag (see FIG. 2). The slave processor 11 advances processing in parallel with the DMA transfer. The slave processor 11 can acknowledge completion of DMA transfer of all data by referencing the completion flag in the management table 14.

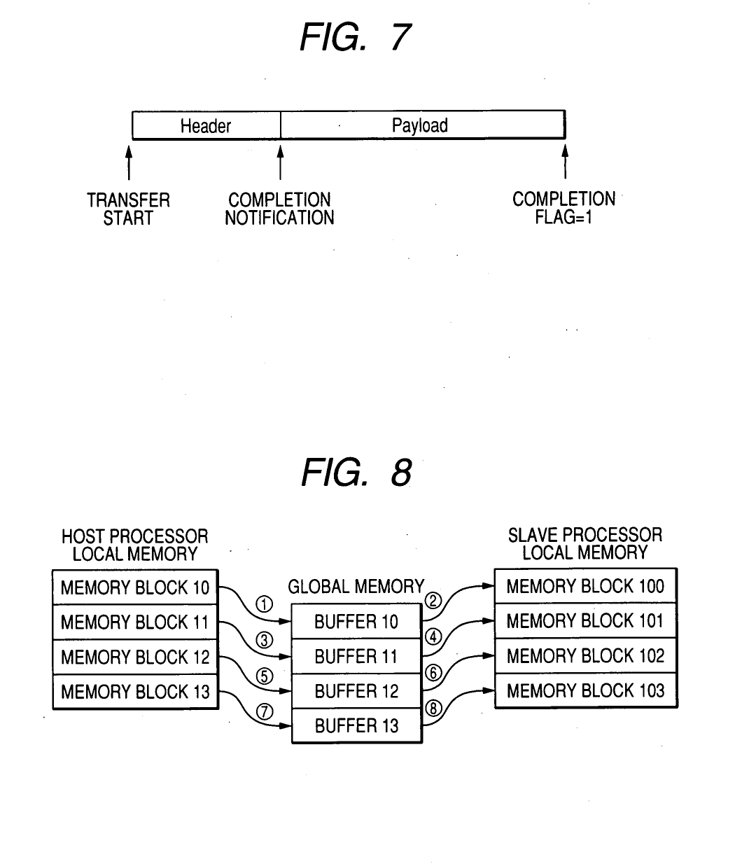

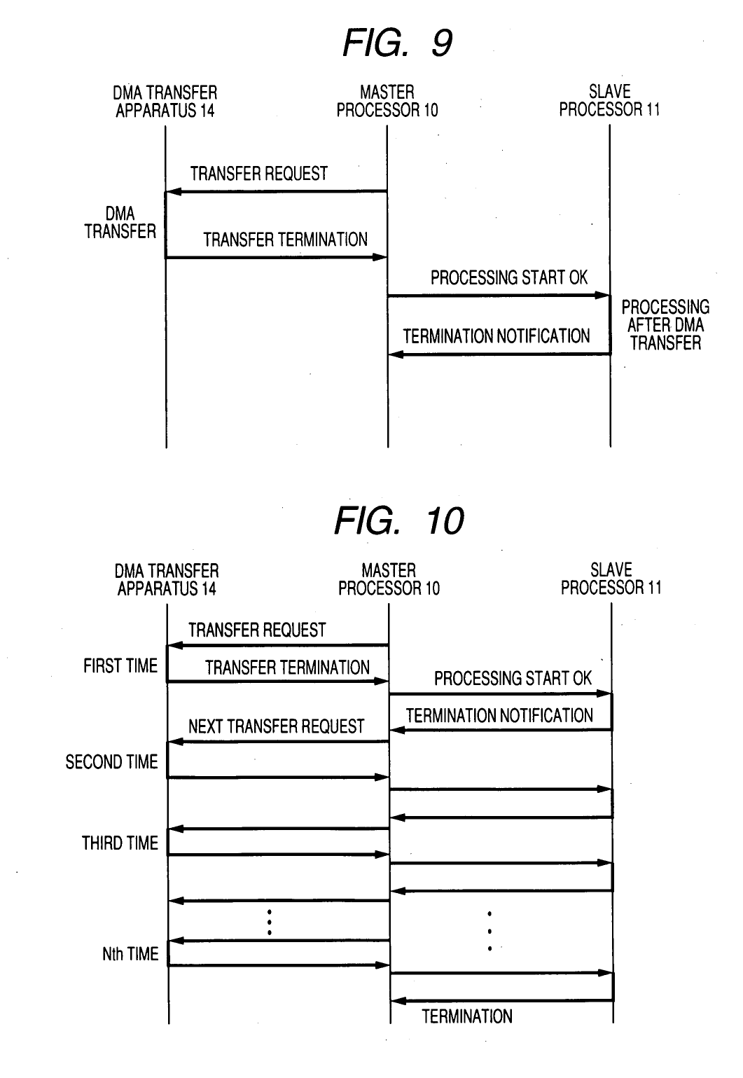

As the timing at which a transfer termination notification is issued is changed, to process stream data of a structure having a header part and a payload part following the head part, for example, as shown in FIG. 7, the notification timing is defined so as to issue a transfer termination notification at the point in time when DMA transfer of the header part terminates, whereby the slave processor 11 can advance processing relevant the header (header analysis, etc.,) without waiting for the termination of DMA transfer of all data. The number of already transferred data pieces rather than the number of untransferred data pieces may be defined as the notification timing. Timer management of the notification timing may be adopted.

FIG. 8 shows how data in memory blocks 10, 11, 12, and 13 allocated in the local memory that the master processor has is copied into memory blocks 100, 101, 102, and 103 in the local memory that the slave processor has in memory block units through the global memory. In this case, DMA transfer from the local memory that the master processor has to the global memory (1, 3, 5, 7) and DMA transfer from the global memory to the local memory that the slave processor has (2, 4, 6, 8) need to be executed.

The DMA transfer apparatus first starts DMA transfer 1. Upon completion of DMA transfer 1, the DMA transfer apparatus issues a transfer termination notification to the DMA transfer apparatus. The DMA transfer apparatus assigns an unused DMA channel to DMA transfer 2 and at the same time, starts DMA transfer 3. After this, likewise, every DMA transfer is executed in a pipeline manner. DMA transfer parameters are set in the management table in the DMA transfer order. The DMA transfer apparatus receives the DMA transfer termination notification and executed the DMA transfer, whereby the load on the processor can be lightened as compared with the DMA transfer in the related art via the master processor.

The DMA transfer apparatus of the invention issues a transfer termination notification directly to a specific destination without the intervention of the master processor, so that the load on the processor can be decreased. Since a transfer termination notification is issued only to a specific slave processor, the need for any other slave processor to determine the transfer termination notification is eliminated, so that the load on the processor can be decreased and the DMA transfer apparatus of the invention is useful as a DMA transfer apparatus, etc., for executing processor-to-processor DMA transfer in a multiprocessor system including a plurality of processors.

What is claimed is:

1. A DMA transfer apparatus for executing DMA transfer between local memory that each processor has and global memory shared by the processors, said DMA transfer apparatus comprising:
a table for managing destinations to which a notification of DMA transfer termination is to be sent; and
a controller for issuing a DMA transfer termination notification to the destination determined by referencing said table.

2. The DMA transfer apparatus as claimed in claim 1 wherein said table manages the timing at which a notification of DMA transfer termination is to be sent, and wherein
said controller issues a DMA transfer termination notification at the timing determined by referencing said table.

3. The DMA transfer apparatus as claimed in claim 2 wherein said table manages the timing defined as the number of untransferred data pieces or the number of already transferred data pieces.

4. The DMA transfer apparatus as claimed in claim 1 wherein said table manages a slave processor as the destination to which a notification of DMA transfer termination is to be sent.

5. The DMA transfer apparatus as claimed in claim 1 wherein said table manages said table as the destination to which a notification of DMA transfer termination is to be sent.
